(19) United States
(12) Patent Application Publication
(10) Pub. No.: US 2025/0104497 A1
(43) Pub. Date: Mar. 27, 2025

(54) Access Control for a Motor Vehicle

(71) Applicant: Bayerische Motoren Werke Aktiengesellschaft, Muenchen (DE)

(72) Inventors: Marco HIPPLER, Muenchen (DE); Thorsten Knott, Tuntenhausen (DE)

(21) Appl. No.: 18/814,664

(22) Filed: Aug. 26, 2024

(30) Foreign Application Priority Data
Sep. 26, 2023 (DE) 10 2023 126 142.8

(51) Int. Cl. G07C 9/00; H04W 4/029; H04W 4/44; H04W 12/041; H04W 12/069

(52) U.S. Cl. CPC G07C 9/00658; H04W 4/029; H04W 4/44; H04W 12/041; H04W 12/069; G07C 2209/02

(57) ABSTRACT

A method for controlling access to a motor vehicle includes steps of creating a digital key for access to the motor vehicle on the part of a friend device; signing the created key by an owner device of the motor vehicle; transmitting a tracking request for the signed key to a tracking service; transmitting a tracking response from the tracking service to the friend device; wherein the tracking response comprises encrypted information of the tracking service; and presenting the encrypted information to the motor vehicle by the friend device. In this case, the tracking response comprises additional information that the tracking service has obtained from a manufacturer service in relation to the tracking request.

### CROSS REFERENCE TO RELATED APPLICATION

This application claims priority under 35 U.S.C. § 119 from German Patent Application No. 10 2023 126 142.8, filed Sep. 26, 2023, the entire disclosure of which is herein expressly incorporated by reference.

### BACKGROUND AND SUMMARY

The present invention relates to access control for a motor vehicle. In particular, the invention relates to access control by means of a digital vehicle key.

Access to a motor vehicle may be protected by means of a digital key. The digital key may be stored on a device. The device and the motor vehicle can authenticate one another, and a request to use a predetermined function of the motor vehicle can be executed upon successful authentication. To put it more precisely, a mutual authentication can preferably be effected on the basis of an asymmetric cryptographic encryption method in which the device and the motor vehicle are in each case assigned a pair composed of a private and a public cryptographic key.

The owner may pass an authorization to use the whole motor vehicle or only a predetermined function to a friend. In order to create a valid key for the friend, a predetermined exchange method can be carried out, which includes communication with a central entity that can manage keys for the motor vehicle. A tracking service can be implemented to document when which keys with authorizations were active for which functions of a motor vehicle. If a key is to be passed from an owner to a friend, the friend can be recorded or documented with the tracking service. A newly created key cannot become valid until the tracking service has confirmed the key.

At the time of authentication of the friend with respect to the motor vehicle, it may be advantageous for the motor vehicle already to have available specific additional information from the external entity. For this purpose, the external entity may transmit the additional information in encrypted form to the motor vehicle. Under certain circumstances, however, direct communication between the external entity and the motor vehicle is not possible before the newly created key is to be used, for example because a wireless connection has been disrupted.

An object on which the present invention is based consists in providing a method by which additional information from the external entity can be securely transferred to the motor vehicle. The method achieves this object by means of the subjects of the independent claims. Preferred embodiments are specified in dependent claims.

Hereinafter, it is simply stated that a motor vehicle communicates with a device, even though the communication is strictly speaking handled by a control apparatus on board the motor vehicle. The communication is preferably wireless, for which reason one or more different wireless interfaces may be provided by the motor vehicle. A preferred data interface includes Bluetooth (BT) or Bluetooth Low Energy (BLE); a preferred interface for relative positioning of a device relative to the motor vehicle preferably includes ultra-wideband (UWB). A communicating device may comprise wireless interfaces for one or both protocols.

An owner is understood here as a person who is specifically assigned to the motor vehicle and holds particular authorizations. These authorizations may include, in particular, the creation or signing of another key for the motor vehicle. There may be multiple owners of the motor vehicle at one time. For a control or exchange method described herein, the owner acts by means of an owner device. The owner device preferably comprises a mobile device that is personally assigned to the owner, in particular a smartphone, a smart watch, a smart band, a tablet computer or a laptop computer. In order to use the owner device for a sensitive action within the scope of a technique described herein, it may be necessary for the owner to be authenticated with respect to the owner device. For this purpose, the owner may present a biometric feature or enter a secret (password, PIN). Authentication can be checked by an operating system of the mobile device.

A friend is understood here to be a person who is to be granted authorization to use the motor vehicle. Like the owner, the friend is usually a natural person. With regard to a technique described herein, the friend preferably acts by means of a friend device that is preferably personally assigned to them, like the owner device is assigned to the owner. The friend may also be authenticated with respect to the friend device in order to trigger a security-sensitive operation within the scope of the technique described herein.

According to a first aspect of the present invention, a method for controlling access to a motor vehicle comprises steps of creating a digital key for access to the motor vehicle on the part of a friend device; signing the created key by an owner device of the motor vehicle; transmitting a tracking request for the signed key to a tracking service; transmitting a tracking response from the tracking service to the friend device; wherein the tracking response comprises encrypted information of the tracking service; and presenting the encrypted information to the motor vehicle by the friend device. In this case, the tracking response comprises additional information that the tracking service has obtained from a manufacturer service in relation to the tracking request.

The manufacturer service may concern a data management service of a manufacturer of the motor vehicle. Information about the motor vehicle, an owner or other relevant information may be stored here. The tracking service may be required for legal or insurance-related reasons in order to document creation, presence or revocation of a digital key for a motor vehicle.

It has been recognized that a mechanism by which the tracking service transmits release information to the friend device can be used to securely bring additional information to the motor vehicle while a direct connection between the manufacturer service and the motor vehicle is not usable. The additional information may be present at the motor vehicle as early as before or exactly at the time of a first authentication of the friend device with respect to the motor vehicle. In particular, the information may be decrypted by the motor vehicle before an authentication with the friend device has taken place.

Digital keys or pairs of keys of an asymmetric cryptographic method may be used for securely transmitting the additional information. In a similar manner to the owner device, the friend device and the motor vehicle, it is also possible for the manufacturer service and the tracking service in each case to be assigned a public and a private cryptographic key. In a known manner, one device can encrypt a message using a public key of another device and deliver it to the other device even via an insecure medium. The other device can decrypt the message by means of its private key. All other devices cannot decrypt the message. The additional information can be encrypted by the manufacturer service or by the tracking service using a public key of the motor vehicle, such that the additional information can be decrypted again only by the motor vehicle itself. Information transmitted from the tracking service to the friend device can be encrypted using a public key of the friend device. In this way, the additional information can be transported to the motor vehicle in a nested encryption via the tracking service and the friend device.

It is preferred for the motor vehicle to evaluate the additional information in order to control access to the motor vehicle on the part of the friend device. For this purpose, it is particularly preferred for the additional information to be transmitted in encrypted form to the motor vehicle even before an authentication takes place between the friend device and the motor vehicle.

A technique described herein advantageously builds on a concept known as a digital vehicle key or Digital Car Key. A specification of the Digital Car Key is published by the Car Connectivity Consortium and is available at the time of writing this document in version 1.1.0 of Jul. 20, 2022. In particular, reference is made to chapter 11.8 “Key Sharing Flow: Steps”, 11.9 “Owner Device OEM Server Notification”, 11.10 “Key Tracking and Online Attestation Delivery” and 11.11 “Vehicle Attestation”.

The additional information may be forwarded to the motor vehicle in the context of data transmission that is known as friend first approach in regard to the aforementioned standard. This approach is explained in more specific detail in chapter 19.5.8.2 of the aforementioned documentation. It is preferred for the additional information to be transmitted in the context of a friend first approach. After the corresponding steps have been carried out, the friend device may be known to the motor vehicle and a further friend first approach is usually not carried out any more.

In one embodiment, the additional information comprises an indication of a key of a friend device or owner device that has been declared invalid. The motor vehicle may delete the relevant key from an internal memory.

There are usually only a finite number of memory locations available for keys of friend or owner devices at the motor vehicle. In order to prevent all the memory locations from being occupied, a key in the memory may be removed on the basis of the indication in the additional information, thereby creating space for a new key, in particular the key of the present friend device.

In another embodiment, the additional information comprises a device class of the friend device. Exemplary device classes include a smartphone, a smart watch, a smart band, a laptop computer, a tablet computer or a handheld device (fob). This additional information may be used for informative purposes and for example control a symbol indicating the specified device class on an output apparatus of the motor vehicle. In a further embodiment, the device class can be taken into account in order to differentiate communication control or release control. In this regard, for example, a wearable computer may have a lower processing power than a smartphone. Cryptographic procedures demanded of the friend device may be less complex if a wearable is involved, and more complex if a smartphone is involved, for example.

According to a further embodiment, the additional information comprises data that are characteristic of an identification of the friend device at a predetermined user service. The friend may have a plurality of devices that may be used as friend devices for controlling the use of the motor vehicle. These devices may be synchronized with one another by way of a uniform user identifier. The user service may be managed in particular by a manufacturer of the friend device. By way of example, for devices from Apple, an Apple ID is known as user identifier. A plurality of friend devices may be managed jointly by way of a uniform Apple ID. In particular, a digital key may be transferred from one friend device to another. The additional information may comprise the user identifier as a cryptographic hash value. In this regard, it is not possible for the user identifier to be determined by being inferred from the additional information.

In a further embodiment, it is assumed that owner devices of the motor vehicle are each assigned a serial number. The additional information may comprise the number of that owner device which has signed the key of the friend device. Access to the motor vehicle on the part of the friend device may only be allowed if a current owner device with the serial number of the signing owner device is known. In this respect, an additional measure may be taken in order to prevent a case in which, between the issuing of the key to the friend device and the first access to the motor vehicle, the owner device which signed the key of the friend device loses owner status with regard to the motor vehicle. This may be the case, for example, if the motor vehicle is sold or the key of the owner device is declared invalid for other reasons.

According to yet another embodiment, the additional information comprises an indication of a usable function of a method for access control. The method for access control that is carried out between the owner device, the friend device, the motor vehicle, the manufacturer service and the tracking service may be developed further or subjected to changes. The additional information may specify a version number of a standard according to which access control is intended to take place. In this regard, for example, a participant may demand the latter's adherence to a predetermined minimum version of the standard. Conversely, for example, if a weak point becomes known in a new function, implementation of an older or lower version of the access control may be constrained by way of the additional information.

According to yet another embodiment, the additional information specifies an additional authentication factor required for access to the motor vehicle. In particular, a second factor of a two-factor authentication method may be specified in this way. Such a second factor may require a transaction number to be entered at the motor vehicle, for example, the transaction number having previously been sent to the friend device via SMS, for example.

The specification of the additional authentication factor may be present in the manner of a bitmap. In this case, a plurality of additional authentication factors may be predetermined and the additional information may comprise a plurality of required authentication factors. In one embodiment, a plurality of alternatively usable additional authentication factors may be specified. In another embodiment, a plurality of authentication factors may be specified, all of which are required in order to gain access to the motor vehicle.

According to a further aspect of the present invention, a system comprises a motor vehicle, an owner device, a friend device, a manufacturer service and a tracking service, which are set up to carry out a method described herein.

According to a still further aspect of the present invention, a tracking service is set up to receive a tracking request from a friend device; to determine additional information from an external entity; to encrypt the additional information and to transmit it in a tracking response to a friend device.

Preferably, the tracking service is additionally set up to store or to document information about a key that is the subject of the tracking request. The tracking request concerns a digital key for a motor vehicle. Additional information may originate in particular from a manufacturer service of the motor vehicle. The additional information may be related to the motor vehicle, an owner, the latter's owner device, a friend or the latter's friend device.

Other objects, advantages and novel features of the present invention will become apparent from the following detailed description of one or more preferred embodiments when considered in conjunction with the accompanying drawing.

### BRIEF DESCRIPTION OF THE DRAWING

FIG. 1 shows a system for controlling access to a motor vehicle.

### DETAILED DESCRIPTION OF THE DRAWING

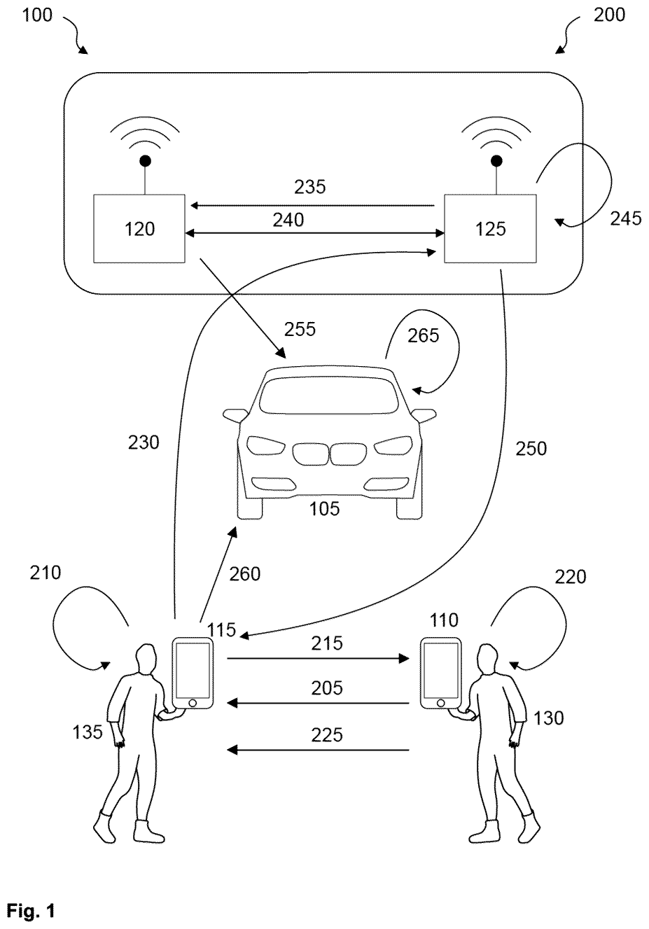

In FIG. 1, the system 100 comprises a motor vehicle 105, an owner device 110, a friend device 115, a manufacturer service 120 and a tracking service 125. The owner device 110 is assigned to an owner 130, and the friend device 115 is assigned to a friend 135. The owner 130 and the friend 135 preferably comprise natural persons, who are each able to use the motor vehicle 105 in a predetermined manner. The use may comprise, in particular, opening a door or a flap or driving with the motor vehicle 105. The owner 130 is authorized to have the motor vehicle 105 available to them and, in particular, to pass on an authorization to use the motor vehicle 105 to the friend 135.

The manufacturer service 120 may be operated by a manufacturer of the motor vehicle 105. The manufacturer can also be referred to as an OEM, and the manufacturer service 120 can also be referred to as an OEM server 120. Information about the motor vehicle 105 and one or more persons assigned to it may be stored in the manufacturer service 120. The tracking service 125 has the task of tracking or documenting keys with which the motor vehicle 105 can be used. The tracking service 125 can also be referred to as the key tracking server. It should be noted that names used herein are based on the abovementioned standard of the Digital Car Key. The intention is to match the names or terms used there.

FIG. 1 further shows a method 200 for controlling access to the motor vehicle 105. Method steps are shown as arrows between elements of the system 100. The method 200 may be part of an access control process described in the context of the Digital Car Key. It is proposed to extend the access control described in the standard through the transmission of additional information in the method 200 described below.

In a step 205, the owner 130 can transmit a configuration to the friend 135, the configuration containing specifications about which motor vehicle 105 is to be used in what manner with a digital key to be created.

In a step 210, the friend device 115 can generate a key that corresponds to the given configuration. In a step 215, the generated key can be transmitted from the friend device 115 to the owner device 110 for signing.

In a step 220, the owner device 110 of the owner 130 can digitally sign the transmitted key of the friend device 115 cryptographically. In a step 225, the owner device 110 can transmit an import prompt together with an attestation package to the friend device 115. The attestation package may contain information about what further steps must be taken by the friend device 115 to validate the generated key.

In a step 230, the friend device 115 can transmit the attestation package together with a tracking request to the tracking service 125. The tracking service 125 can inform the manufacturer service 120 of the received tracking request in a step 235. Subsequently, in a step 240, predetermined data related to the key of the friend device 115 can be exchanged between the manufacturer service 120 and the tracking service 125. In a step 245, the tracking service 125 can sign the created key of the friend device 115 and store additional information that the tracking service 125 has received from the manufacturer service 120 in a predetermined memory area of the digital key. In regard to the Digital Car Key, a private mailbox or a confidential mailbox can be used as such a memory area. In addition, the tracking service 125 can store information about the created or signed key.

In a step 250, the key can be transmitted, together with the additional information obtained from the manufacturer service 120, from the tracking service 125 to the friend device 115. Concurrently therewith, in a step 255, the manufacturer service 120 can transmit the additional information directly to the motor vehicle 105. It should be noted that, under certain circumstances, this step cannot be carried out before the friend 135 with the friend device 115 attempts to use the motor vehicle 105.

In a step 260, the friend device 115 is at a communication distance from the motor vehicle 105. Information which may include an identification of the key of the friend device 115 and the aforementioned additional information can be exchanged. Such an initial data transfer is known in the Digital Car Key standard as the friend first approach. It should be noted that an actual authentication between the friend device 115 and the motor vehicle 105 can only take place later once the additional information from the private or confidential mailbox of the key has already been forwarded to the motor vehicle 105.

In a step 265, the received additional information can be evaluated on board the motor vehicle 105. Subsequently, access to the motor vehicle 105 on the part of the friend device 115 can be controlled depending on the additional information transferred.

Additional information that can advantageously be transmitted to the motor vehicle 105 via the tracking service 125 and the friend device 115 is described in summary again below.
1.) Specification of a cryptographic key which is stored in an internal memory of the motor vehicle 105 and which is to be deleted. The memory contains keys of known devices and has a limited number of memory locations for such keys.
2.) Specification of a device class of a friend device 115 on which a key for using the motor vehicle 105 is stored. Exemplary device classes include wearable, smartphone or personal computer.
3.) Specification of one or more additional factors to be used for activating or using the key. This specification may be embodied as a bitmap, such that one or more out of predetermined factors may be specified.
4.) Hash value of a user identifier of the friend 135. The user identifier may concern a service, an operating system or a mobile device 115 of the friend 135. May be used to group together stored keys of the friend 135.
5.) Sequential number of that owner 130 who has signed the key of the friend 135. If a new owner 130 is added at the motor vehicle 105, then the new owner acquires a new sequential number. If an owner 130 is removed, then this owner's key is deleted. May be used as an additional measure for preventing the use of a key of a friend 135 whose signing owner 130 has been removed in the meantime.
6.) Specification of features or functions which should be used or should not be used. In one embodiment, specification of a minimum and/or maximum version number of a standard according to which access control using a digital key is intended to take place.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### REFERENCE SIGNS

100 System
105 Motor vehicle
110 Owner device
115 Friend device
120 Manufacturer service (OEM server)
125 Tracking service (key tracking server)
130 Owner
135 Friend
200 Method
205 Request to generate a key, with configuration
210 Friend device generates key with entitlement
215 Prompt to sign the key
220 Owner device signs key
225 Import prompt with attestation package
230 Friend device sends tracking request to tracking service
235 Tracking service notifies manufacturer service
240 Exchange of shared key data
245 Tracking service signs key with additional information and stores the key
250 Tracking response: transmit signature and additional information to friend device
255 Signature with additional information from the manufacturer service to the motor vehicle
260 First contact of the friend device with the motor vehicle
265 Evaluate additional information

What is claimed is:

1. A method for controlling access to a motor vehicle, the method comprising the steps of:
creating a digital key for access to the motor vehicle on the part of a friend device;
signing the created digital key by an owner device of the motor vehicle;
transmitting a tracking request for the signed created digital key to a tracking service;
transmitting a tracking response from the tracking service to the friend device;
wherein the tracking response comprises encrypted information of the tracking service; and
presenting the encrypted information to the motor vehicle by the friend device;
wherein the tracking response comprises additional information that the tracking service has obtained from a manufacturer service in relation to the tracking request.

2. The method according to claim 1, wherein
the motor vehicle evaluates the additional information in order to control access to the motor vehicle on the part of the friend device.

3. The method according to claim 1, wherein
the additional information comprises an indication of a key of a friend device or owner device that has been declared invalid; wherein the motor vehicle deletes the key from an internal memory.

4. The method according to claim 1, wherein the additional information comprises a device class of the friend device.

5. The method according to claim 1, wherein
the additional information comprises data that are characteristic of an identification of the friend device at a predetermined user service.

6. The method according to claim 5, wherein the user service is managed by a manufacturer of the friend device.

7. The method according to claim 1, wherein
owner devices of the motor vehicle are each assigned a serial number;
the additional information comprises the number of the owner device which has signed the key of the friend device; and
wherein access to the motor vehicle on the part of the friend device is only allowed when a current owner device with the serial number of the signing owner device is known.

8. The method according to claim 1, wherein the additional information comprises an indication of a usable function of a method for access control.

9. The method according to claim 1, wherein the additional information specifies an additional authentication factor required for access to the motor vehicle.

10. The method according to claim 9, wherein
a plurality of additional authentication factors are predetermined, and
the additional information comprises a plurality of required authentication factors.

11. A system, comprising:
a motor vehicle;
an owner device;
a friend device;
a manufacturer service; and
a tracking service,
wherein the system is operatively configured to:
create a digital key for access to the motor vehicle on the part of the friend device;
sign the created digital key by the owner device of the motor vehicle;
transmit a tracking request for the signed created digital key to the tracking service;
transmit a tracking response from the tracking service to the friend device;
wherein the tracking response comprises encrypted information of the tracking service; and
present the encrypted information to the motor vehicle by the friend device;
wherein the tracking response comprises additional information that the tracking service has obtained from the manufacturer service in relation to the tracking request.

12. A method of operating a tracking service, the method comprising:
receiving a tracking request from a friend device determining additional information from an external entity;
encrypting the additional information; and
transmitting the encrypted additional information in a tracking response to a friend device.
